(19) United States
(12) Patent Application Publication
(10) Pub. No.: US 2016/0258580 A1
(43) Pub. Date: Sep. 8, 2016

(54) LED LIGHT BULB AND MANUFACTURING METHOD THEREOF

(71) Applicants: Ming Sun, Pudong, Shanghai (CN); Xing-Bao Chen, Pudong, Shanghai (CN); Shanghai Oppellighting Co., Ltd., Pudong, Shanghai (CN)

(72) Inventors: Ming SUN, Shanghai (CN); Wen-Jung CHUANG, Suzhou City (CN); Jian DAI, Shanghai (CN); Xing-Bao CHEN, Shanghai (CN)

(21) Appl. No.: 14/395,081

(22) PCT Filed: Aug. 15, 2014
(86) PCT No.: PCT/CN2014/084508

§ 371 Date: Oct. 17, 2014

(30) Foreign Application Priority Data
Sep. 30, 2013 (CN) 201310459326.6

(51) Int. Cl. F21K 99/00; F21V 9/16; F21V 29/85; F21V 23/00; F21V 17/10; F21V 31/00; F21V 3/04; F21V 19/00

(52) U.S. Cl. CPC F21K 9/1355; F21V 3/0418; F21K 9/90; F21V 9/16; F21V 19/002; F21V 23/001; F21V 17/101; F21V 31/005; F21V 29/86

(57) ABSTRACT

The present invention includes a LED light bulb and the manufacturing method thereof. The manufacturing method includes the following steps. In the step A, produce a LED light source. In the step B, fasten the LED light source. The LED light bulb of the present invention is related to the LED lightening lamp and includes a LED light source, a frame, a lampshade, a lamp holder and a power supply. The LED light source is installed on the frame and sheltered via the lampshade. The LED light source and the power supply are electrically coupled together via a lead. The power supply is installed inside the lamp stand. Consequently, the cost may be reduced and the processes of the LED light bulb may be simplified as well.

### BACKGROUND OF THE INVENTION

1. Field of the Invention

The present invention is related to a LED lightening apparatus and, especially, is related to a LED light bulb and the manufacturing method thereof.

2. Descriptions of the Related Art

In the market of LED light bulb, the bulb is generally exerted for living and is mostly in the shape of sphere or spheroid, wherein the sphere bulb is much more popular. Hence, the LED light bulb used for replacing the traditional incandescent bulb becomes the novel green light source.

In the aspect of the environmental issue and shortage of resources, the traditional incandescent bulb (tungsten bulb) is forbidden in many countries due to its high energy consumption and short lifetime. Consequently, the electronic energy-saving lamp becomes a good substitute because of its notable energy-saving performance. Unfortunately, because the electronic energy-saving lamp contains lots of heavy metals, it makes the electronic energy-saving lamp become an environmental unfriendly product so that the electronic energy-saving lamp must be abandoned.

With fortune, the development of LED is fast and it gradually makes the LED lightening become the best choice of the novel green light source, wherein the LED lightening gets better performance than the traditional lightening dose due to it notable lightening theorem, energy-saving ability and environmental friendly features.

The traditional LED light bulb mainly includes a glass shade or an acrylic shade, a lens, a heat dispenser, an Al substrate, a chamber for casing the power (usually inside the heat dispenser), plastic connecting elements for isolation, a couple (such as E27, M16 and so on), a light source mainly including a bead type and a integrate-power type, and a power supply. Apparently, for the traditional LED light bulb, the mechanism and the assembling are quite complicated so that the cost is extremely high. Hence, the traditional LED light bulb is still faced with some difficulties to replace the traditional incandescent bulb due to the critical factors. A LED light bulb having simple assembling, lower costing and improved performances is the solution for completely replacing the current spheroid bulbs in the worldwide living market.

### SUMMARY OF THE INVENTION

It is an objective of this invention to provide a LED light bulb and the manufacturing method thereof to simplify the complicated configurations, to lower the cost and meanwhile improve the performances of the traditional LED light bulb.

To solve the problems mentioned, the present invention provides a manufacturing method of a LED light bulb including the following steps.

Step A: produce a LED light source.

Step A1: exert a glass substrate having at least two electrodes and the chips are installed on the glass substrate via a fluorescent gel.

Step A2: electrically couple the chip to the other chips and the electrodes via the leads.

Step A3: directly cover the glass substrate, the chips and the electrodes via the fluorescent gel.

Step B: fasten the LED light source.

Step B1: exert a hollow glass frame having a glass stand melt with two conductive wires, wherein one end of each conductive wire electrically coupled to the LED light source through the hollow glass frame and the other end of each conductive wire electrically coupled to a positive electrode and a negative electrode of the power supply through the glass stand.

Step B2: exert a glass lampshade having the frame with the LED light source inside and seal the glass lampshade via melting the glass lampshade and the glass stand together.

Step B3: purge air inside the glass lampshade through the hollow glass frame and inject a mixture of He and N.

Step B4: seal the hollow glass frame and keep an air pressure of the glass lampshade ranging from 0.05 to 0.15 MPa at room temperature.

Step B5: electrically couple the power supply inside the glass stand to the conductive wires of the glass frame and assemble the glass stand and the lampshade together.

In one embodiment of the present invention, as exerting single the LED light source, the conductive wires are electrically coupled to the electrodes of the LED light source individually.

In one embodiment of the present invention, as exerting at least two of the LED light sources, an amount of the LED light sources is N=X+Y and all the LED light sources are electrically coupled and are installed in one end of the hollow glass frame, wherein the X is an integral and P electrodes of X of the LED light sources are led out and fixed to electrically couple to the positive electrode of the power supply, the Y is an integral and N electrodes of Y of the LED light sources are led out and fixed to electrically couple to the negative electrode of the power supply, wherein the end of the hollow glass frame is not a bottom end of the hollow glass frame.

In the embodiment mentioned above, the N is an even and X=Y.

In one embodiment of the present invention, the mixture is prepared via mixing He:N from 5:1 to 2:1 in volume.

In one embodiment of the present invention, the electrodes are prepared via PVD vacuum sputtering: first, sputter a Cr layer on the glass substrate and finally sputter a Ni layer on the Cr layer to form the electrodes.

In the embodiment mentioned above, the voltage of the vacuum sputtering is controlled from 300V to 600V, the current of the vacuum sputtering is controlled from 4 A to 8 A, the chamber pressure of the vacuum sputtering is 5*10⁻³ Pa and the operation time is ranging from 0.5 hr to 1.0 hr.

In the embodiment mentioned above, the thickness of the Cr layer is ranging from 0.5 μm to 1 μm and the thickness of the Ni layer is ranging from 50 nm to 100 nm.

In one embodiment of the present invention, the glass substrate is sorted according to its width as a glass sheet or a glass fiber and the glass sheet is wider than the glass fiber wherein the thickness of the glass sheet is ranging from 0.5 mm to 1.1 mm, the thickness of the glass fiber is ranging from 0.3 mm to 1.2 mm and the width of the glass fiber is ranging from 0.5 mm to 10 mm.

In the embodiment mentioned above, the thickness of the glass fiber is ranging from 0.3 mm to 0.6 mm.

In one embodiment of the present invention, the LED light source is electrically coupled to an external electrode on the conductive wire, wherein the electrode installed on the glass substrate of the LED light source is plugged into the external electrode.

Meanwhile, a LED light bulb manufactured via the method mentioned above is also provided in the present invention. The LED light bulb includes a LED light source, a frame, a lampshade, a stand and a power supply, wherein the frame is a hollow glass frame having a glass stand, the lampshade is a glass lampshade having the frame with the LED light source inside. The power supply is installed inside the stand which is sealed with the glass lampshade to form a closed space. Wherein, the conductive wires of the LED light source electrically couple to the power supply installed inside the lamp stand along the frame. The mixture of He and N is injected into the glass lampshade, wherein He:N is ranging from 5:1 to 2:1 in volume and the air pressure is ranging from 0.05 to 0.15 MPa at room temperature.

In one embodiment of the present invention, the LED light source includes at least one individual LED light source having at least two chips installed on the glass substrate via the fluorescent gel, wherein the chips are electrically coupled via the leads. Except for the electrodes on the glass substrate, the glass substrate, the chips and the leads are packed via covering the fluorescent gel.

In one embodiment of the present invention, the glass substrate is a patterned glass substrate including a periodic matrix pattern having salient hemispheres, cones, tapers, polyhedral tapers or yurts. The period of patterning is ranging from 1 μm to 10 μm, the bottom width is ranging from 5 μm to 25 μm and the height is ranging from 0.1 μm to 5 μm.

In one embodiment of the present invention, the patterned glass substrate further includes a patterned MN layer with the thickness ranging from 500 Å to 3000 Å. The patterned MN layer has a reticular interval pattern, wherein the interval pattern is regular equilateral triangle or equilateral polygon having a side-length larger than 0.8 nm and the area ranging from 10 μm² to 1000 μm². The distance of two adjacent intervals is larger than 10 μm.

It is effectively to excite the LED chip for lightening in the operation state via covering the fluorescent gel. Also, the wires are protected and fixed via the fluorescent gel. Hence, the isolated wires are not easy to break so that the LED damage would be avoided. The present invention provides a conductive wire having an external electrode so that the electrode installed on the glass substrate of the LED light source could be plugged into the external electrode. Because it is quite difficult to directly install the external electrode on the LED chip based on the intrinsic property of the glass substrate, the traditional metal external electrode is installed on the glass substrate via adhering or soldering. Although it is simple, low-cost and easy to operate via adhering and/or soldering, the interface between the electrode and the glass substrate has poor heat resistance. In the present invention, the external electrode is fixed via plugging so that the electrode and the glass substrate are well connected and the heat resistance of the interface is greatly improved. Meanwhile, it is easier to process the electrode on the chip and the cost can be lower as well.

The performance of the LED light bulb would be affected via the thickness of the glass substrate. The glass substrate would be sorted as glass sheet and glass fiber according to different widths. The glass sheet is wider than the glass fiber, wherein, in the present invention, the best performance of the LED light bulb would be achieved as the thickness of the glass sheet is ranging from 0.5 mm to 1.1 mm. The present invention can stabilize the LED light source via reducing the effect of serial conductive wires and can improve the sealing at the same time.

To simplify the configuration of the traditional LED light bulb, the glass substrate of the present invention is AlN-sputtered after patterned. Hence, the adhesive directly between the sputtered AlN and the glass substrate is improved and the efficiency for heat dissipation is improved as well. Meanwhile, the pattern of the glass substrate and the pattern of the sputtered AlN are nanometer-scaled so that the particles of the fluorescent gel are too large to permeate among the patterns while coating the fluorescent gel onto the glass substrate. Consequently, several holes are formed between the patterns and the fluorescent gel. Accordingly, under the effect of the heat energy generated via operated LED light source, the air inside the holes is heated and convected rapidly to accelerate the heat dissipation rate of the glass substrate.

### BRIEF DESCRIPTION OF THE DRAWINGS

The present invention will become more fully understood from the detailed description given hereinbelow illustration only, and thus are not limitative of the present invention, and wherein:

FIG. 1 illustrates a LED light source of the present invention adhering LED chips on the glass substrate.

FIG. 2 illustrates a LED light source of the present invention.

FIG. 3 illustrates a LED light source of the present invention.

FIG. 4 illustrates a glass-fiber-type LED light bulb of the present invention.

FIG. 5 illustrates a glass-sheet-type LED light bulb of the present invention.

FIG. 6 illustrates test tables of operation temperature and luminous flux for different types of LED light bulbs of the present invention.

FIG. 7 illustrates a thermal analysis table for the LED light bulbs with different thicknesses of glass substrate.

### EXPLANATIONS OF LETTERS OR NUMERALS

1 chip
2 patterned glass substrate
2a patterned sputtered MN
3 lead
4 fluorescent gel
5 glass substrate
6 electrode
7 light stand
8 power supply
9 LED light source
10 lampshade
11 frame
12 air
13 external electrode
14 conductive wire

### DESCRIPTION OF THE PREFERRED EMBODIMENT

In the following description, this invention will be explained with reference to embodiments thereof. However, the description of these embodiments is only for purposes of illustration rather than limitation. It should be appreciated that in the following embodiments and attached drawings, elements unrelated to this invention are omitted from depictions; and dimensional relationships among individual elements in the attached drawings are illustrated only for ease of understanding, but not to limit the actual scale.

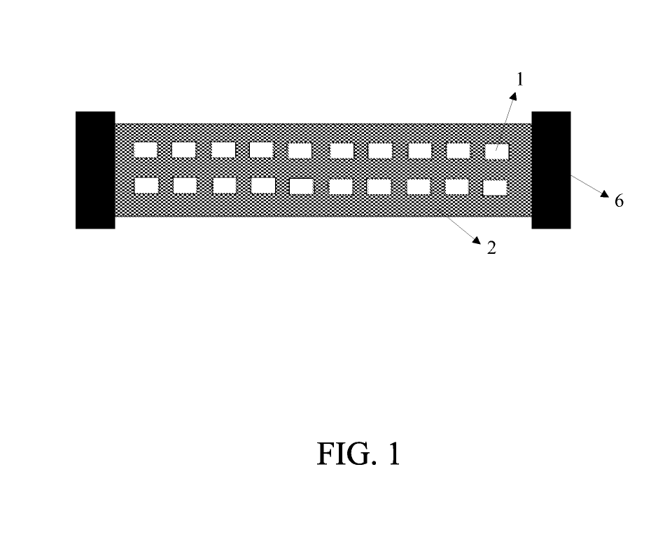

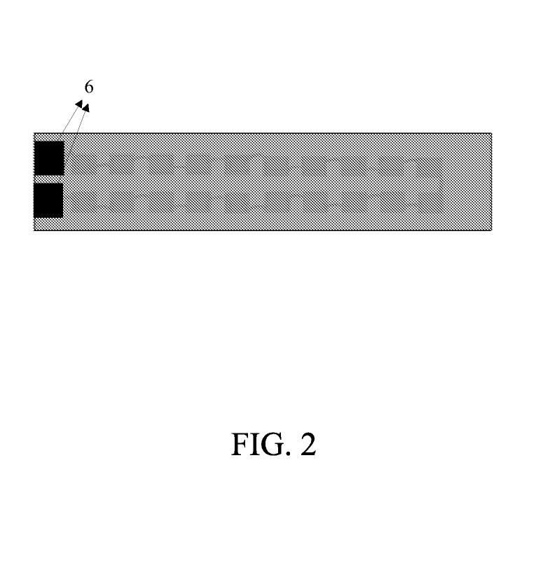

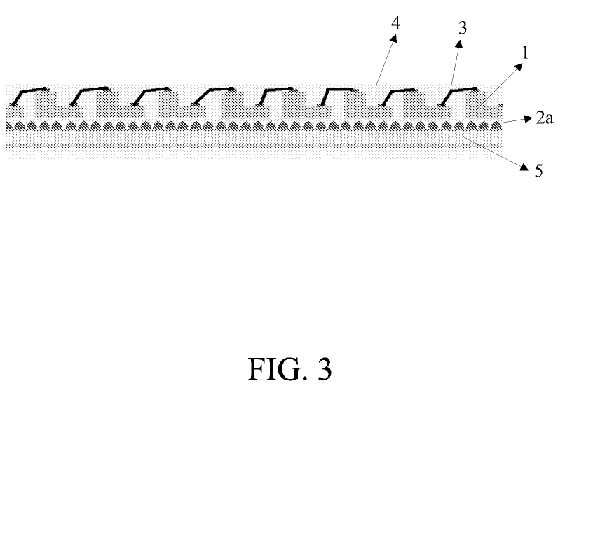

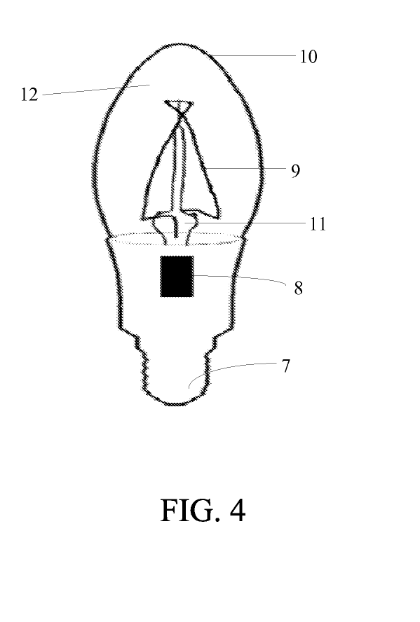

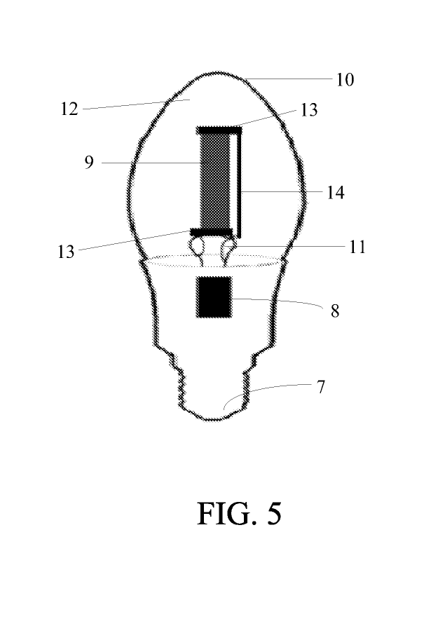

Please refer to FIG. 1 to FIG. 5. A LED light bulb and the manufacturing method thereof are disclosed in the present invention. The manufacturing method of the LED light bulb includes the following steps. First, from manufacturing the light source as the beginning, choose the glass as the substrate for replacing the traditional aluminum substrate to increase the luminous efficiency. It almost has no luminance in the back of the LED chip due to the traditional opaque aluminum substrate. The glass substrate of the present invention is almost totally transparent such that the LED chip 1 can be luminous in all directions. At least two electrodes 6 are installed on every glass substrate 5. The electrodes 6 are electrically coupled to the LED chip 1. The LED chip 1 is installed on the surface of the glass substrate 5 via the fluorescent gel 4. Metal leads 3 electrically couple the chip 1 to the chip 1 and also the chip 1 to the electrode 6. The glass substrate 5 (the electrodes are not included), the chip 1 and the leads 3 are all covered via the fluorescent gel 4 so that the luminance of the LED chip 1 can be excited and the leads 3 are fixed and protected to avoid breaking and/or damaging.

The electrodes 6 are formed on the glass substrate 5 via PVD (Physical Vapor Deposition) in vacuum to increase the adhesion. Sputter a Cr layer on the glass substrate 5 and later sputter a Ni layer on the Cr layer to form the electrodes. The voltage of the vacuum sputtering is controlled from 300V to 600V. The current of the vacuum sputtering is controlled from 4 A to 8 A. The chamber pressure of the vacuum sputtering is 5*10⁻³ Pa and the operation time is ranging from 0.5 hr to 1.0 hr. The thickness of the Cr layer is ranging from 0.5 μm to 1 μm and the thickness of the Ni layer is ranging from 50 nm to 100 nm.

The best method to electrically couple the LED light source 9 and the conductive wire 14 is to plug the electrode 6 of the glass substrate 5 of the LED light source into the external electrode 13 on the conductive wire 14. Due to the intrinsic property of the glass substrate 5, it is very difficult to lay-out the external electrode 13 directly coupled to the LED chip 1. Generally, the simplest and low-cost method to adhere the metal external electrode 13 to the glass substrate 5 is to exert the adhesive or soldering material. However, the heat resistant of this method is extremely poor. Ensure that the LED light bulb is vacuum-sealed, the glass lampshade 10 and the glass frame 11 are melt to seal at 250° C. so that the LED light source 9 is sealed inside the lampshade 10. The high process temperature would lead to LED damage due to the break between the external electrode 13 and the glass substrate 5 which are adhered together. The plug-type external electrode 13 may ensure the excellent connection of the external electrode 13 and the glass substrate 5. Meanwhile, the poor heat resistance of the adhesive may be avoided. The process of the electrode of the chip is simplified and cost-down.

The performance of the LED light bulb would be affected via the thickness of the glass substrate. The glass substrate would be sorted as glass sheet and glass fiber according to different widths. The glass sheet is wider than the glass fiber, wherein, in the present invention, the best performance of the LED light bulb would be achieved as the thickness of the glass sheet is ranging from 0.5 mm to 1.1 mm. The thickness of the glass fiber is ranging from 0.3 mm to 1.2 mm and the width of the glass fiber is ranging from 0.5 mm to 10 mm, wherein the thickness of the glass fiber is ranging from 0.3 mm to 0.6 mm.

Fasten the LED light source. In order to improve the luminous efficiency and the sealing quality of the LED, exert a hollow glass frame having a glass stand melt with two conductive wires 14. Both the ends of each of conductive wires 14 are led from the frame 11. One end of the conductive wire 14 is electrically coupled to the LED light source 9 and is exerted for fixing one end of the LED light source 9. The other end of the conductive wire 14 is electrically coupled to a positive electrode and a negative electrode of the power supply 8 through the frame 11. The conductive wires 14 are fixed via the melt glass stand of the frame so that the stability of the LED light source 9 would not be greatly affected via the serial conductive wires 14. Also, the sealing quality is improved.

When the LED light bulb of the present invention has only one LED light source 9, the conductive wires 14 exerted to fix the LED light source 9 are electrically coupled to the two electrodes of the LED light source 9. When the LED light bulb has two or more LED light sources 9 and the total amount of the LED light sources 9 is N which satisfied with the equation X+Y=N wherein both X and Y are the integral, one ends of each of LED light sources 9 are electrically coupled and are installed in one end away from the bottom of the glass frame. P electrodes of X of the LED light sources 9 are led out and fixed to electrically couple to the positive electrode of said power supply 8. N electrodes of Y of the LED light sources 9 are led out and fixed to electrically couple to the negative electrode of said power supply 8. Generally, the ends of the conductive wires 14 coupled to the positive/negative electrodes of the power supply 8 are in the bottom of the glass frame.

Exert a glass lampshade 10 having the frame 11 with the LED light source 9 inside and seal the glass lampshade 10 via melting the glass lampshade 10 and the glass stand of the frame 11 together. Purge air inside the glass lampshade 10 through the hollow glass frame for avoiding the damage to the LED light source 9 from the original air inside and then inject a mixture of He and N into the glass lampshade 10. The He/N mixture is prepared via mixing He:N from 5:1 to 2:1 in volume. The working LED light bulb has the excellent heat dissipation efficiency under the air pressure from 0.05 to 0.15 MPa at room temperature. Electrically couple the power supply 8 inside the glass stand 7 to the conductive wires 14 of the frame 11. Assemble the glass stand 7 and the lampshade 10 together and complete the process of the LED light bulb of the present invention.

In order to simplify the configuration of the traditional LED light bulb, the light bulb of the present invention includes a LED light source 9, a frame 11, a lampshade 10, a stand 7 and a power supply 8. Inside the lampshade 10, the LED light source 9 is installed on the frame 11. The power supply 8 is installed inside the stand 7 sealed with the frame 7 to form a closed space. The conductive wires 14 of the LED light source 9 along the frame 11 electrically couple to the power supply 8 installed inside the stand 7. The mixture of He and N is injected into the lampshade 10, wherein He:N is ranging from 5:1 to 2:1 in volume and the air pressure is ranging from 0.05 to 0.15 MPa at room temperature.

Each LED light source 9 of the LED light bulb of the present invention may have at least two chips 1 installed on the glass substrate 5 via the fluorescent gel 4, wherein the chips 1 are electrically coupled via the leads 3. Except for the electrodes on the glass substrate 5, the glass substrate 5, the chips 1 and the leads 3 are packed via covering the fluorescent gel 4.

In order to increase the surface area of the heat dissipation for the LED light source 9 of the LED light bulb of the present invention, the glass substrate 5 is a patterned glass substrate 2 including a periodic matrix pattern having salient hemispheres, cones, tapers, polyhedral tapers or yurts. The period of patterning is ranging from 1 μm to 10 μm, the bottom width is ranging from 5 μm to 25 μm and the height is ranging from 0.1 μm to 5 μm. The patterned glass substrate 2 further includes a patterned MN layer with the thickness ranging from 500 Å to 3000 Å. The patterned MN layer has a reticular interval pattern, wherein the interval pattern is regular equilateral triangle or equilateral polygon having a side-length larger than 0.8 μm and the area ranging from 10 μm² to 1000 μm². The distance of two adjacent intervals is larger than 10 μm. The process temperature of the patterned MN layer is lower than 130° C. In order to improve the etching performance, the surface of the glass substrate 5 is washed via an acid solvent. The acid solvent is prepared via mixing the acid and the water ranging from 1:5 to 1:10 in volume, wherein the acid is also exerted to etch the glass substrate 5 in the later process step such as hydrochloric acid or phosphoric acid or sulfuric acid. The etching process duration is ranging from 3 min to 8 min. The process for the glass substrate 5 may be implemented via two manufacturing methods. One method is to pattern the glass substrate 5 in the beginning step. Wash the glass substrate 5 via the acid solvent and coat a photo resistance. Expose the photo resistance for developing and then etch. Coat another photo resistance on the patterned glass substrate 2. Pattern the photo resistance for developing and then etch. After 2^{nd}-patterned, sputter the MN layer at the operation temperature lower than 130° C. for avoiding the negative photo resistance burned on the surface of the glass substrate 5 due to the high temperature. Remove the photo resistance so that the patterned MN layer may reveal on the patterned glass substrate 2. The other method is to sputter the MN layer on the glass substrate 5. Coat a photo resistance on the surface of the MN layer. Expose the photo resistance for developing. Etch the glass substrate 5 having the sputtered MN layer to produce a patterned glass substrate 2 having the patterned MN layer 2a. The present method of sputtering the MN layer on the glass substrate 5 with pattern can increase the adhesion between the MN layer and the glass substrate 5. The glass substrate 5 of the present invention is AlN-sputtered after patterned. Hence, the adhesive directly between the sputtered MN and the glass substrate 5 is improved and the heat dissipation efficiency is improved as well. Meanwhile, the pattern of the glass substrate 5 and the pattern of the sputtered MN are nanometer-scaled so that the particles of the fluorescent gel 4 are too large to permeate among the patterns while coating the fluorescent gel 4 onto the glass substrate 5. Consequently, several holes are formed between the patterns and the fluorescent gel 4. Accordingly, under the effect of the heat energy generated via operated LED light source 9, the air inside the holes is heated and convected rapidly to accelerate the heat dissipation rate of the substrate.

If one LED light bulb of the present invention has more than one LED light source 9 and all the light sources 9 are uniform, and assume that the amount of the LED light sources 9 is N=X+Y, X and Y are the integral, X is an even and X=Y are true, the electrical parameters of each LED light source 9 are mostly the same so that the LED light bulb can get most stable performance during operation respectively.

### Embodiment 1

### Glass Substrate

Exert a glass substrate 5 and etch the masked glass substrate 5 to form the periodic matrix yurt-patterns. The period of yurt-patterns is around 10 μm and the height is around 2.5 μm. Sputter the AlN layer on the surface of the patterned glass substrate 2 and etch the masked patterned glass substrate 2 to form the reticular interval pattern, wherein the interval pattern is regular equilateral hexagon having a side-length around 3 μm. The distance of two adjacent intervals is ranging from 3 μm to 7 μm. Manufacture the electrode on the surface of the glass substrate 5 and adhere the LED chips 1 onto the glass substrate 5. Metal leads 3 electrically couple the chip 1 to the chip 1 and also the chip 1 to the electrode. The glass substrate 5 (the electrodes are not included), the chip 1 and the leads 3 are all covered via the fluorescent gel 4 so that the luminance of the LED chip 1 can be excited and the leads 3 are fixed and protected to avoid breaking and/or damaging.

### Embodiment 2

### Test Data for Different LED Light Bulbs

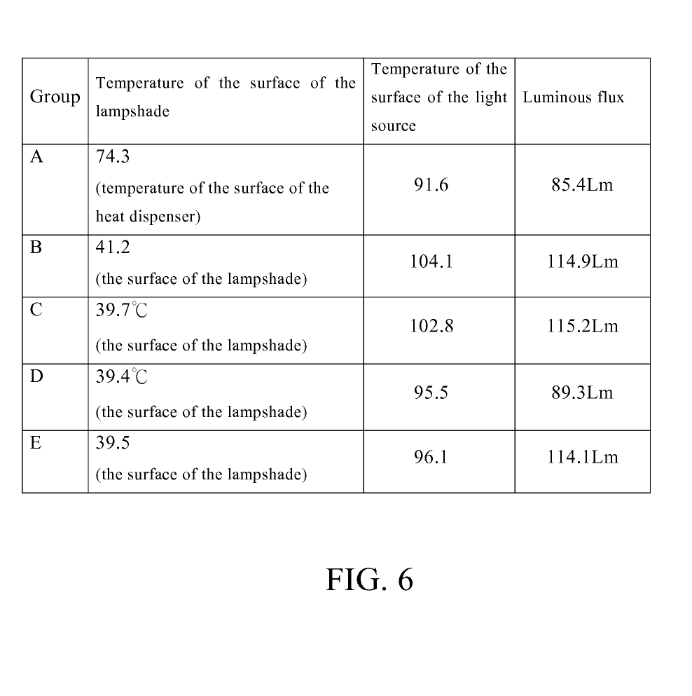

Different LED light bulbs are tested and the results are illustrated hereinafter. All the LED light bulbs are divided into five groups and each group has 15 bulbs. The A-group is the traditional LED light bulb including a glass shade, a lens, a heat dispenser, an Al substrate, a chamber for casing the power supply, plastic connecting elements, a couple, a light source and a power supply. The B-group is the LED light bulb of the present invention which includes the glass substrate 5 and the glass lampshade 10 filled with the mixture of He and N. The C-group is the LED light bulb of the present invention which includes the glass substrate 5 that is etched for patterning. The D-group is the LED light bulb sputtered an AlN layer on the surface of the patterned substrate of the C-group. The E-group is the LED light bulb having the patterned sputtered AlN layer of the D-group. The quality, amount and all performances of the chips 1 of the LED light bulbs are uniform. In the steady state of lightening, the temperature of the surface of the lampshade 10, the temperature of the surface of the light source and the luminous flux of all bulbs are recorded for the temperature test and the luminous flux test. According to the data recorded, as illustrated in FIG. 6, calculate an average for each group and round off to the nearest tenth.

The powers of the LED light bulbs of each group are 1.2 W. The LED is drove via the capacitor. The inspection apparatuses include one-meter integrating sphere and DCUU TMC-16 temperature data logging device (K-type thermocouple probe/surface temperature and standard thermocouple probe). The inspection is done in the LED laboratory at 26° C. and 75% RH humidity.

According to the results illustrated in FIG. 6, the luminous fluxes of the LED light bulbs of the present invention are obviously better though having a little bit higher surface temperature. Further, the E-group shows better performances of surface temperature and luminous flux than other groups do.

### Embodiment 3

### Thermal Analysis for LED Light Bulbs with Different Thicknesses of Glass Substrate

At first, measure the LED light source 9 exerting the same 1023 chip 1 with different substrate thicknesses at the atmosphere. Put the light source mentioned into the bulb. And then vacuum, inject mixed gas and seal the bulb. Measure the initial luminous flux and the steady luminous flex after lightening for calculating the heat accumulation rate. Accordingly, the effects of different thicknesses of the glass substrate 5 for the LED light bulb can be inferred.

First, produce the LED light source 9. Exert 15 glass substrates for each thickness of 0.3 mm, 0.4 mm, 0.5 mm, 0.6 mm, 0.7 mm, 0.8 mm, 0.9 mm, 1.0 mm, 1.1 mm and 1.2 mm. Each glass substrate 5 has two electrodes. Exert the fluorescent gel 4 to fix the chips 1 on the substrate. The leads 3 electrically couple the chip 1 to the chip 1 and also the chip 1 to the electrodes. The glass substrate 5, chips 1 and leads 3 are all directly cover via the fluorescent gel 4 so that the LED light source 9 is completed. Randomly select five samples of the glass substrates 5 from each thickness and measure the initial luminous flux and steady luminous flux of the LED light source 9 after lightening. Calculate the heat accumulation rate via the following formula:

$$Heat Accumulation Rate = \frac{initial luminous flux - steady luminous flux}{initial luminous flux}$$

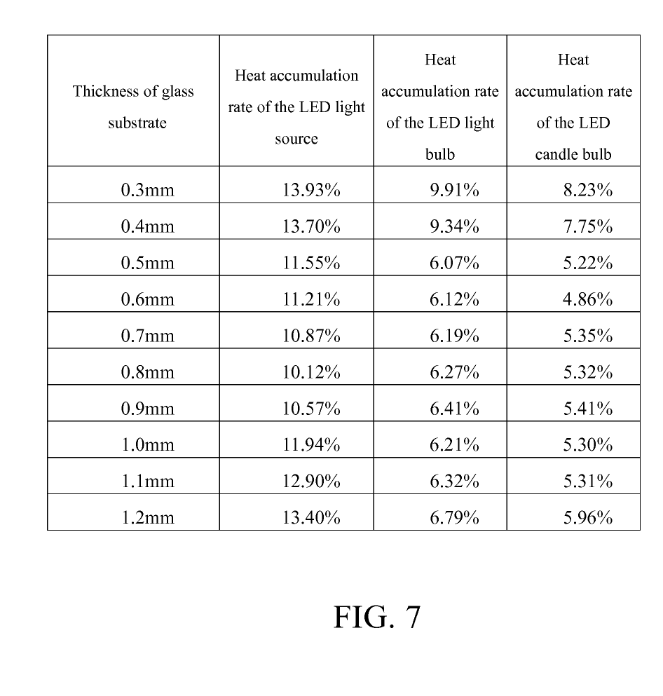

Calculate and record the average for each thickness and the thermal analysis results are illustrated in FIG. 7. Then, randomly select five samples for each LED light source 9 to produce the LED light bulbs. Install each LED light source 9 on a glass frame and then put unto a glass lampshade 10. Seal the glass lampshade 10 after injecting the mixture of He and N till the air pressure reaches to 0.10 MPa, wherein the He and N are controlled in the ratio of 3:1 in volume. Electrically couple the power supply 8 inside the stand 7 to the conductive wires 14 of the glass frame 11. At last, assemble the stand 7 and the lampshade 10 so that the LED light bulb of the present invention is completed. Measure and calculated the initial luminous flux, steady luminous flux and the heat accumulation rate of the LED light bulbs after lightening. Calculate and record the average and the results are illustrated in FIG. 7. The rest LED light sources 9 are exerted to produce the candle bulbs. Follow the same procedure to measure, calculate and record the heat accumulation rate and the results are illustrated in FIG. 7 as well. (The higher heat accumulation rate is; the lower steady luminous flux is.)

In the present invention, the heat accumulation rate of the LED light source 9 is around 12% but the heat accumulation rate can almost be reduced 50% if the LED light source 9 is exerted for producing the LED light bulb. Furthermore, based on a plenty of experiments, the thickness of the glass substrate 5 of the LED light source 9 is crucial for determining the heat accumulation rate of the LED light bulb/candle bulb. However, the glass substrate 5 must have a certain thickness range from 0.5 mm to 1.1 mm to achieve the lowest heat accumulation rate of the LED light bulb. The thickness that is too thin or too thick is not recommended.

The above embodiments merely give the detailed technical contents of the present invention and inventive features thereof, and are not to limit the covered range of the present invention. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

1. A manufacturing method of a LED light bulb including the following steps:
Step A: produce a LED light source; and
Step A1: exert a glass substrate having at least two electrodes and several chips are installed on said glass substrate via a fluorescent gel;
Step A2: electrically couple said chip to said other chips and said electrodes via several leads; and
Step A3: directly cover said glass substrate, said chips and said electrodes via said fluorescent gel;
Step B: fasten said LED light source;
Step B1: exert a hollow glass frame having a glass stand melt with two conductive wires wherein one end of each wire electrically coupled to said LED light source through said hollow glass frame and the other one end of each wire electrically coupled to a positive electrode and a negative electrode of said power supply through said glass stand;
Step B2: exert a glass lampshade having said frame with said LED light source inside and seal said glass lampshade via melting said glass lampshade and said frame together;
Step B3: purge air inside said glass lampshade through said hollow glass frame and inject a mixture of He and N;
Step B4: seal said hollow glass frame and keep an air pressure of said glass lampshade ranging from 0.05 to 0.15 MPa at room temperature; and
Step B5: electrically couple said power supply inside said glass stand with said conductive wires of said glass frame and assemble said glass stand and said lampshade together.

2. The manufacturing method of a LED light bulb of claim 1, wherein as exerting single said LED light source, said conductive wires are electrically coupled to said electrodes of said LED light source individually.

3. The manufacturing method of a LED light bulb of claim 1, wherein as exerting at least two of said LED light sources, an amount of said LED light sources is N=X+Y and all said LED light sources are electrically coupled and are installed in one end of said hollow glass frame, wherein said X is an integral and P electrodes of X of said LED light sources are led out and fixed to electrically couple to said positive electrode of said power supply, said Y is an integral and N electrodes of Y of said LED light sources are led out and fixed to electrically couple to said negative electrode of said power supply, wherein said end of said hollow glass frame is not a bottom end of said hollow glass frame.

4. The manufacturing method of a LED light bulb of claim 3, wherein said N is an even and X=Y.

5. The manufacturing method of a LED light bulb of claim 1, wherein said mixture is prepared via mixing He:N from 5:1 to 2:1 in volume.

6. The manufacturing method of a LED light bulb of claim 1, wherein said electrodes are prepared via PVD vacuum sputtering: first, sputter a Cr layer on said glass substrate and finally sputter a Ni layer on said Cr layer to form said electrodes.

7. The manufacturing method of a LED light bulb of claim 6, wherein a voltage of said vacuum sputtering is controlled from 300V to 600V, a current of said vacuum sputtering is controlled from 4 A to 8 A, a chamber pressure of said vacuum sputtering is 5*10⁻³ Pa and an operation time is ranging from 0.5 hr to 1.0 hr.

8. The manufacturing method of a LED light bulb of claim 6, wherein a thickness of said Cr layer is ranging from 0.5 μm to 1 μm and a thickness of said Ni layer is ranging from 50 nm to 100 nm.

9. The manufacturing method of a LED light bulb of claim 1, wherein said glass substrate is sorted according to its width as a glass sheet or a glass fiber and said glass sheet is wider than said glass fiber wherein a thickness of said glass sheet is ranging from 0.5 mm to 1.1 mm, a thickness of said glass fiber is ranging from 0.3 mm to 1.2 mm and a width of said glass fiber is ranging from 0.5 mm to 10 mm.

10. The manufacturing method of a LED light bulb of claim 9, wherein a thickness of said glass fiber is ranging from 0.3 mm to 0.6 mm.

11. The manufacturing method of a LED light bulb of claim 1, wherein said LED light source is electrically coupled to an external electrode of said conductive wire, wherein said electrode installed on said glass substrate of said LED light source is plugged into said external electrode on said conductive wire.

12. A LED light bulb manufactured via the method as defined in claim 1, said LED light bulb includes said LED light source, a frame, a lampshade, a stand and said power supply, wherein said frame is said hollow glass frame having said glass stand, said lampshade is said glass lampshade having said frame with said LED light source inside, said power supply is installed inside said stand and said stand is sealed with said glass lampshade to form a closed space, wherein said conductive wires of said LED light source electrically couple to said power supply installed inside said lamp stand along said glass frame, and said mixture of He and N is injected into said glass lampshade, wherein He:N is ranging from 5:1 to 2:1 in volume and said air pressure is ranging from 0.05 to 0.15 MPa at room temperature.

13. The LED light bulb of claim 12, wherein said LED light source includes at least one individual LED light source having at least two chips installed on said glass substrate via said fluorescent gel, wherein said chips are electrically coupled via said leads and, except for said electrodes on said glass substrate, said glass substrate, said chips and said wires are packed via covering said fluorescent gel.

14. The LED light bulb of claim 13, wherein said glass substrate is a patterned glass substrate including a periodic matrix pattern having salient hemispheres, cones, tapers, polyhedral tapers or yurts, wherein a period of patterning is ranging from 1 μm to 10 μm, a bottom width is ranging from 5 μm to 25 μm and a height is ranging from 0.1 μm to 5 μm.

15. The LED light bulb of claim 14, wherein said patterned glass substrate further includes a patterned AlN layer with a thickness ranging from 500 Å to 3000 Å and said patterned AlN layer has a reticular interval pattern, wherein said interval pattern is regular equilateral triangle or equilateral polygon having a side-length larger than 0.8 μm and an area ranging from 10 μm² to 1000 μm², and a distance of said two adjacent intervals is larger than 10 μm.

16. A LED light bulb manufactured via the method as defined in claim 2, said LED light bulb includes said LED light source, a frame, a lampshade, a stand and said power supply, wherein said frame is said hollow glass frame having said glass stand, said lampshade is said glass lampshade having said frame with said LED light source inside, said power supply is installed inside said stand and said stand is sealed with said glass lampshade to form a closed space, wherein said conductive wires of said LED light source electrically couple to said power supply installed inside said lamp stand along said glass frame, and said mixture of He and N is injected into said glass lampshade, wherein He:N is ranging from 5:1 to 2:1 in volume and said air pressure is ranging from 0.05 to 0.15 MPa at room temperature.

17. A LED light bulb manufactured via the method as defined in claim 3, said LED light bulb includes said LED light source, a frame, a lampshade, a stand and said power supply, wherein said frame is said hollow glass frame having said glass stand, said lampshade is said glass lampshade having said frame with said LED light source inside, said power supply is installed inside said stand and said stand is sealed with said glass lampshade to form a closed space, wherein said conductive wires of said LED light source electrically couple to said power supply installed inside said lamp stand along said glass frame, and said mixture of He and N is injected into said glass lampshade, wherein He:N is ranging from 5:1 to 2:1 in volume and said air pressure is ranging from 0.05 to 0.15 MPa at room temperature.

18. A LED light bulb manufactured via the method as defined in claim 4, said LED light bulb includes said LED light source, a frame, a lampshade, a stand and said power supply, wherein said frame is said hollow glass frame having said glass stand, said lampshade is said glass lampshade having said frame with said LED light source inside, said power supply is installed inside said stand and said stand is sealed with said glass lampshade to form a closed space, wherein said conductive wires of said LED light source electrically couple to said power supply installed inside said lamp stand along said glass frame, and said mixture of He and N is injected into said glass lampshade, wherein He:N is ranging from 5:1 to 2:1 in volume and said air pressure is ranging from 0.05 to 0.15 MPa at room temperature.

19. A LED light bulb manufactured via the method as defined in claim 5, said LED light bulb includes said LED light source, a frame, a lampshade, a stand and said power supply, wherein said frame is said hollow glass frame having said glass stand, said lampshade is said glass lampshade having said frame with said LED light source inside, said power supply is installed inside said stand and said stand is sealed with said glass lampshade to form a closed space, wherein said conductive wires of said LED light source electrically couple to said power supply installed inside said lamp stand along said glass frame, and said mixture of He and N is injected into said glass lampshade, wherein He:N is ranging from 5:1 to 2:1 in volume and said air pressure is ranging from 0.05 to 0.15 MPa at room temperature.

20. A LED light bulb manufactured via the method as defined in claim 6, said LED light bulb includes said LED light source, a frame, a lampshade, a stand and said power supply, wherein said frame is said hollow glass frame having said glass stand, said lampshade is said glass lampshade having said frame with said LED light source inside, said power supply is installed inside said stand and said stand is sealed with said glass lampshade to form a closed space, wherein said conductive wires of said LED light source electrically couple to said power supply installed inside said lamp stand along said glass frame, and said mixture of He and N is injected into said glass lampshade, wherein He:N is ranging from 5:1 to 2:1 in volume and said air pressure is ranging from 0.05 to 0.15 MPa at room temperature.

21. A LED light bulb manufactured via the method as defined in claim 7, said LED light bulb includes said LED light source, a frame, a lampshade, a stand and said power supply, wherein said frame is said hollow glass frame having said glass stand, said lampshade is said glass lampshade having said frame with said LED light source inside, said power supply is installed inside said stand and said stand is sealed with said glass lampshade to form a closed space, wherein said conductive wires of said LED light source electrically couple to said power supply installed inside said lamp stand along said glass frame, and said mixture of He and N is injected into said glass lampshade, wherein He:N is ranging from 5:1 to 2:1 in volume and said air pressure is ranging from 0.05 to 0.15 MPa at room temperature.

22. A LED light bulb manufactured via the method as defined in claim 8, said LED light bulb includes said LED light source, a frame, a lampshade, a stand and said power supply, wherein said frame is said hollow glass frame having said glass stand, said lampshade is said glass lampshade having said frame with said LED light source inside, said power supply is installed inside said stand and said stand is sealed with said glass lampshade to form a closed space, wherein said conductive wires of said LED light source electrically couple to said power supply installed inside said lamp stand along said glass frame, and said mixture of He and N is injected into said glass lampshade, wherein He:N is ranging from 5:1 to 2:1 in volume and said air pressure is ranging from 0.05 to 0.15 MPa at room temperature.

23. A LED light bulb manufactured via the method as defined in claim 9, said LED light bulb includes said LED light source, a frame, a lampshade, a stand and said power supply, wherein said frame is said hollow glass frame having said glass stand, said lampshade is said glass lampshade having said frame with said LED light source inside, said power supply is installed inside said stand and said stand is sealed with said glass lampshade to form a closed space, wherein said conductive wires of said LED light source electrically couple to said power supply installed inside said lamp stand along said glass frame, and said mixture of He and N is injected into said glass lampshade, wherein He:N is ranging from 5:1 to 2:1 in volume and said air pressure is ranging from 0.05 to 0.15 MPa at room temperature.

24. A LED light bulb manufactured via the method as defined in claim 10, said LED light bulb includes said LED light source, a frame, a lampshade, a stand and said power supply, wherein said frame is said hollow glass frame having said glass stand, said lampshade is said glass lampshade having said frame with said LED light source inside, said power supply is installed inside said stand and said stand is sealed with said glass lampshade to form a closed space, wherein said conductive wires of said LED light source electrically couple to said power supply installed inside said lamp stand along said glass frame, and said mixture of He and N is injected into said glass lampshade, wherein He:N is ranging from 5:1 to 2:1 in volume and said air pressure is ranging from 0.05 to 0.15 MPa at room temperature.

25. A LED light bulb manufactured via the method as defined in claim 11, said LED light bulb includes said LED light source, a frame, a lampshade, a stand and said power supply, wherein said frame is said hollow glass frame having said glass stand, said lampshade is said glass lampshade having said frame with said LED light source inside, said power supply is installed inside said stand and said stand is sealed with said glass lampshade to form a closed space, wherein said conductive wires of said LED light source electrically couple to said power supply installed inside said lamp stand along said glass frame, and said mixture of He and N is injected into said glass lampshade, wherein He:N is ranging from 5:1 to 2:1 in volume and said air pressure is ranging from 0.05 to 0.15 MPa at room temperature.
